(19) United States
(12) Patent Application Publication
(10) Pub. No.: US 2007/0241308 A1
(43) Pub. Date: Oct. 18, 2007

(54) Composition for controlling exposure to oxygen

(76) Inventor: Julius Uradnisheck, Glen Mills, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/728,432

(22) Filed: Mar. 26, 2007

Related U.S. Application Data
(60) Provisional application No. 60/791,745, filed on Apr. 13, 2006.

(51) Int. Cl. C01B 3/00

(52) U.S. Cl. 252/188.28; 524/435; 524/413

(57) ABSTRACT

Compositions comprising a polymer having less than 5 aliphatic carbon-carbon double bonds per 100 copolymerized monomer units, an oxidizable metal, and a compound selected from the group consisting of iron salts having ferric ammonium cations are effective oxygen-scavenging compositions. The compositions are suitable for use as components of food and pharmaceutical packaging materials.

### CROSS-REFERENCE TO RELATED APPLICATION

This application claims the benefit of U.S. Provisional Application No. 60/791,745, filed Apr. 13, 2006.

### FIELD OF THE INVENTION

This invention relates to compositions that absorb oxygen and are useful in the manufacture of containers, lidding and other packaging products. The invention also relates to articles made from such compositions.

### BACKGROUND OF THE INVENTION

Many food products and pharmaceuticals are adversely impacted when stored in the presence of oxygen. Methods of mitigating or eliminating oxygen exposure of these oxygen sensitive materials during the packaging process or during storage have been the subject of much research. One strategy that addresses the problem is to remove oxygen from the product by inert gas sparging. Other methods involve use of packets or sachets that contain oxygen absorbing materials that are placed in the package.

It is known from U.S. Pat. No. 4,992,410 to add a reaction promoter, such as sodium chloride, to iron to produce an oxygen absorbing material suitable for use in sachets for food packaging. Other disclosures of such compositions are found in Japanese Unexamined Patent Publication No. 56-121634 (1981) and Japanese Patent 54158386 (1979) which disclose oxygen absorbing compositions comprising iron powder, sodium chloride and a filler, and in Japanese Unexamined Patent Application Kokai 56-148272 (1981) which discloses a five-component oxygen absorbing composition that is a mixture of a) iron or an iron salt, b) a metal halide, c) a carbonate, d) a solid that is reactive with water and e) an amino acid. U.S. Pat. No. 4,908,151 discloses an oxygen absorbent for dry foodstuffs that comprises a) an unsaturated fatty acid and/or a fatty oil containing unsaturated fatty acid, b) a transition metal and/or a transition metal compound and c) a basic substance, for example calcium carbonate.

Another body of art describes compositions suitable for addition to carrier resins that may be used in portions of the packaging material itself for purposes of absorption of headspace oxygen. Examples of such compositions may be found in U.S. Pat. No. 5,364,555, which describes an oxygen scavenging composition that includes a carrier resin, a salicylic acid chelate or complex of a transition metal and an ascorbate compound. Japanese Unexamined Patent Publication 2002-80647 discloses a sheet for use in food packaging that includes a polyolefin resin, iron, a metal halide and an inorganic sulfate. U.S. Pat. No. 5,274,024 also discloses compositions of this type that incorporate iron and various oxidation promoters including sodium chloride and mixtures of sodium chloride with additional electrolytes such as calcium chloride and magnesium chloride. In addition, U.S. Pat. No. 5,744,056 discloses an oxygen scavenging material that includes a polymeric resin, an oxidizable metal, a first electrolyte and an acidifying component that dissociates only slightly into positive and negative ions in aqueous solution.

U.S. Pat. No. 5,211,875 discloses packaging articles that incorporate a layer comprising oxidizable organic compounds, including oxidizable polymers such as polyamides, and a transition metal catalyst. Oxygen scavenging is initiated by exposing the composition to radiation. U.S. Pat. No. 5,021,515 discloses another system that provides a wall for a package that comprises an oxidizable polymer, preferably a polyamide, and a metal catalyst, such as cobalt.

Japanese Unexamined Patent Application Kokai 56-148272 (1981), mentioned above, discloses the use of ferrous sulfate as an alternative for elemental iron in an oxygen scavenging composition. The use of inorganic ferrous compounds such as ferrous sulfate, ferrous chloride, ferrous nitrate, ferrous bromide and ferrous iodide, as well as ferrous salts of organic acids, such as ferrous gallate, ferrous malate and ferrous fumarate, in oxygen absorbing compositions that do not include oxidizable metals is disclosed in U.S. Pat. No. 6,960,376. Similarly, U.S. Pat. No. 6,037,022 discloses the use of ferrous carbonate in an oxygen-scavenging composition free of oxidizable metals. Japanese Unexamined Patent Publication 2002-80647 discloses use of the combination of ferrous sulfate and metallic iron in an oxygen scavenging composition and European Patent Publication 1506718A1 discloses the use of the combination of iron coated with Lewis acid salts, including ferrous chloride as an oxygen scavenging composition. U.S. Pat. No. 4,299,719 discloses a composition that contains ferrous carbonate, iron powder and a metal halide for deodorizing packages.

None of these systems is universally acceptable and there remains a need in the art for compositions and systems that will permit economical and effective control of oxygen exposure in food packaging. An additional concern is that, when used as a part of a packaging system that contacts a food or pharmaceutical, the absorbent must comply with relevant food contact regulations.

### SUMMARY OF THE INVENTION

The present invention is directed to an oxygen scavenging composition comprising
A. a polymer having less than 5 aliphatic carbon-carbon double bonds per 100 copolymerized monomer units;
B. an oxidizable metal; and
C. a compound selected from the group consisting of iron salts having ferric ammonium cations and mixtures thereof, wherein said iron salts have solubilities in water at 25° C. of at least 1 g/100 g water.

The invention is also directed to a laminate comprising
A. a first layer comprising
   1. at least one polymer having less than 5 aliphatic carbon-carbon double bonds per 100 copolymerized monomer units;
   2. an oxidizable metal; and
   3. a compound selected from the group consisting of iron salts having ferric ammonium cations and mixtures thereof, wherein said iron salts have solubilities in water at 25° C. of at least 1 g/100 g water; and
B. at least one additional layer.

### DETAILED DESCRIPTION OF THE INVENTION

The present invention is directed to oxygen scavenging compositions having particular utility as components of packaging materials for food, pharmaceuticals and other materials that are sensitive to the effects of oxygen. As used herein the term “oxygen scavenging composition” means a material or chemical compound that is capable of reacting with or combining with oxygen present in a sealed container, thereby reducing the level of oxygen present in the interior of the container.

The compositions of the invention exhibit effective and often rapid uptake of oxygen. They may be used in fabrication of containers and components of packaging structures, for example as components of one or more layers of container lids, and in container wall compositions. When utilized in such a manner, the compositions are capable of controlling exposure to oxygen of the contents of a package. The oxygen scavenging compositions of the invention are also suitable for use in sachets or packets that may be placed within a container for the purpose of oxygen absorption. Thus, one embodiment of the invention is a packet, formed of an oxygen-permeable material, wherein an oxygen scavenging composition of the invention is present within the packet.

The polymer component of the oxygen scavenging compositions of the invention will often, but not necessarily, be a polymer that is permeable to oxygen. It also must be relatively inert to oxidation itself. That is, polymers suitable for use in the compositions of the invention will have a low degree of aliphatic unsaturation. Specifically, the polymer will have less than 5 aliphatic double bonds, i.e. aliphatic carbon-carbon double bonds, per 100 copolymerized monomer units, preferably less than 1 aliphatic carbon-carbon double bond per 100 copolymerized monomer units. Blends of two or more such polymers are also suitable for use in the compositions of the invention. Thus, a composition of the invention may include an additional polymer, different from the first, selected from the group consisting of polymers having less than 5 aliphatic carbon-carbon double bonds per 100 copolymerized monomer units and mixtures thereof. Preferably the polymer or polymers will also be permeable to water vapor. Thermoplastic resins, thermoset resins or thermoplastic elastomers may be used. Any polymer that has the required low degree of unsaturation into which an effective amount of the oxidizable metal and iron salt can be incorporated, is suitable. Representative examples of thermoplastic resins that may be utilized include polyamides, polyesters, polystyrenes, polycarbonates, polyvinyl acetate, polyvinyl chloride, polyolefin homopolymers and copolymers, such as polyethylene, polypropylene, ethylene alpha-olefin copolymers, such as linear low density polyethylene, ethylene propylene copolymers, ethylene butene copolymers, and ethylene octene copolymers, copolymers of ethylene and a polar comonomer, such as ethylene vinyl acetate copolymers, ethylene alkyl acrylate copolymers, ethylene alkyl methacrylate copolymers, ethylene acrylic acid copolymers, ethylene methacrylic acid copolymers, ethylene maleic acid copolymers, and metal salts, e.g. ionomers of ethylene acrylic acid copolymers, ethylene methacrylic acid copolymers and ethylene maleic acid copolymers. Preferred thermoplastic resins are those commonly used in packaging applications especially polypropylene, polyethylene, ethylene vinyl acetate copolymers, ethylene (meth)acrylic acid copolymers such as Nucrel® acid copolymers, the metal salts of ethylene (meth)acrylic acid copolymers such as Surlyn® ionomer resins, maleic anhydride grafted polyolefins such as Bynel® coextrudable adhesive resins, ethylene alkyl acrylate copolymers such as Elvaloy® AC acrylate copolymers, all of which are available from E. I. du Pont de Nemours and Company; polyamide homopolymers or copolymers such as MXD-6 polyxylylene adipamide produced by Mitsubishi Gas Chemical, nylon 6 and nylon 66, polyethylene terephthalates such as Crystar® polyester resin, and ethylene vinyl alcohol copolymers available from Kuraray Co., Ltd.

Thermoset resins suitable for use as a polymeric component include epoxies, unsaturated polyester resins, unsaturated ethylene alpha-olefin copolymers, such as EPDM, silicone rubbers, polychloroprenes, nitrile rubbers, fluoroelastomers, perfluoroelastomers and other elastomers. Preferred thermoset resins are those compositions that are suitable for food contact applications in accordance with the regulations of the U.S. Food and Drug Administration. Most preferred of this latter type are those resins where the degree of unsaturation is below 1 aliphatic double bond per 100 copolymerized monomer units after finishing or curing.

All the oxygen scavenging compositions of the present invention contain at least one oxidizable metal component. As used herein the term “electrolyte” means a compound that is capable of dissociating into positive and negative ions in aqueous solution. Suitable metal components are oxidizable metals that are capable of being provided in finely divided or particulate form and that have the ability to react with the electrolyte or electrolytes that comprise the other necessary components of the composition. Such metal compounds will always have some amount of metal oxide on their surfaces when exposed to air. In certain embodiments, metal oxides, preferably those selected from the group consisting of oxides of iron, copper, manganese and cobalt may optionally be added to the oxygen scavenging compositions of the invention.

Examples of oxidizable metals suitable for use in the compositions of the invention include iron, copper, manganese and cobalt. Iron is a preferred oxidizable metal because it is highly effective in promoting the oxygen scavenging reaction and it is readily available in finely divided particulate form.

In theory, the reaction between the oxidizable metal, electrolyte and oxygen is an electrochemical reaction and requires both moisture and an electron conductor (i.e. the metal itself) for reaction to occur. The electrochemical nature of the reaction permits control of the reaction merely by protecting the components from moisture. Protection of materials from moisture is common in commercial operations where resins are used and methods and equipment to maintain low moisture environments are well known to those skilled in the art.

A necessary component of the compositions of the present invention is an electrolyte with which the metal reacts. The electrolyte is a solid ferric ammonium salt. These iron salts will have an ammonium cation as well as a ferric cation. A further characteristic of these electrolytes is that they are highly soluble in water. That is, the iron salts have solubilities in water at 25° C. of at least 1 g/100 g water, preferably at least 10 g/100 g, most preferably at least 20 g/100 g water. Ferric ammonium citrate is an especially effective electrolyte. Other iron salts that are suitable for use in this embodiment include ferric ammonium salts of ethylenediaminetetraacetic acid and ferric ammonium alum. A mixture of two or more such compounds may also be utilized.

When dissolved, the ferric ammonium compounds are substantially dissociated into positive and negative ions. In many instances, they will be completely dissociated.

The oxygen scavenging compositions of the invention may additionally comprise additives that do not interfere in a substantial way with the oxygen scavenging ability of the composition. For example, some common additives used in polymer formulations include fillers, such as diatomaceous earth, kaolin or montmorillonite clay, mica flakes, zeolites, molecular sieves, and the like. Plasticizers may be used to alter the modulus of the polymer or its toughness. Pigments, such as titanium dioxide or carbon black, may be added to color the compositions. It is preferred that antioxidants, sometimes present in commercial polymers, be present at levels low enough that they would not substantially impair the oxygen scavenging properties of the composition, e.g. at levels less than 1,000 ppm.

The oxygen scavenging ability of the compositions of the invention is due to a net reaction between gaseous oxygen and the oxidizable metal. This type of reaction is electrochemical in nature and involves the transfer of electrons between the reacting species (i.e. oxygen and oxidizable metal).

For example, if iron is the oxidizable metal, it is believed that the two half-cell electrochemical reactions that are responsible for the overall scavenging effect are:

Anode Half Cell: Fe->2-electrons+Fe⁺⁺

Cathode Half Cell: Fe⁺⁺+¾O₂+½H₂O+2-electrons->FeOOH

Additional cathode half cell reactions that can take place depending on acidity and availability of oxygen are identified and discussed in M. Stratmann, The Atmospheric Corrosion of Iron—A Discussion of the Physico-Chemical Fundamentals of this Omnipresent Corrosion Process, Phys. Chem., vol. 94, no. 6, pp. 626-619, 1990.

In the case of iron, the electrochemical reaction, and hence the oxygen scavenging reaction, will proceed rapidly if the Fe⁺⁺ ions that are believed to be formed in the anode reaction easily migrate from the location where the anode half cell reaction takes place through the reaction medium to the location where the cathode half cell reaction takes place. The medium most likely to be present in oxygen scavenging compositions used in packaging applications is liquid water. Its presence results from manufacturing or processing conditions or from moisture permeability of the packaging material itself. The particular electrolyte or mixture of electrolytes present in the oxidizable compositions of the present invention are capable of enhancing the oxygen scavenging ability of the oxidizable metal component by taking advantage of moisture present. Liquid water layers that are in contact with the oxidizable metal provide a conductive path for ions formed in the anodic reaction. The electrolyte is selected from a group of compounds that are capable of solubilizing such ions by complexation or chelation.

The oxidizable compositions of the invention may also additionally comprise another electrolyte that is not a ferric ammonium salt. Oxygen absorption may be enhanced through the use of a second electrolyte depending on the particular ferric ammonium salt selected. Some examples of suitable additional electrolyte components are compounds selected from the group consisting of salts of organic acids and salts of inorganic acids. Suitable salts are solids at room temperature and have cations selected from the group consisting of alkali metal cations, alkaline earth metal cations, transition metal cations, quaternary ammonium cations, and quaternary phosphonium cations. Salts having mixed cations of these types are also suitable for use as the first electrolyte component. The salts will have a solubility in water at 25° C. of at least 1 g/100 g water, preferably of at least 10 g/100 g water. Examples of such salts include salts of inorganic acids such as alkali metal, alkaline earth and transition metal halides, sulfates, nitrates, carbonates, bicarbonates, iodides, iodates, sulfites and phosphates. Salts of organic acids that may be used include alkali metal, alkaline earth and transition metal tartrates, lactates, citrates, acetates and alginates. Specific species useful as additional electrolyte components include potassium acid tartrate, potassium alginate, potassium bicarbonate, potassium bromide, potassium carbonate, potassium chloride, potassium citrate, potassium hydroxide, potassium iodate, potassium iodide, potassium lactate, potassium sulfate, sodium acetate, sodium alginate, sodium benzoate, sodium bicarbonate, sodium carbonate, sodium citrate, sodium chloride, sodium diacetate, sodium hydroxide, sodium hypophosphite, sodium lactate, sodium potassium chloride, sodium potassium tartrate, sodium propionate, sodium sesquicarbonate, sodium tartrate, sodium thiosulfate, calcium acetate, calcium alginate, calcium chloride, calcium gluconate, calcium glycerophosphate, calcium lactate, calcium pantothenate, calcium propionate, magnesium chloride, magnesium sulfate, copper gluconate, copper sulfate, cupric nitrate, ferric chloride, ferric sulfate, manganese chloride, manganese gluconate, manganese sulfate, ammonium alginate, ammonium bicarbonate, ammonium carbonate, ammonium chloride, dibasic ammonium citrate, ammonium hydroxide, dibasic ammonium phosphate, monobasic ammonium phosphate, and ammonium sulfate. Combinations of such compounds may also be used, for example sodium chloride and calcium chloride. Sodium chloride is a preferred electrolyte because it is readily available and generally recognized as safe for food contact applications.

Another class of electrolytes that may be used as a second electrolyte are certain organic acids including saturated aliphatic and aromatic acids, particularly those having fewer than 20 carbon atoms. Specific organic acids useful in the present invention include, but are not limited to, acetic acid, aconitic acid, adipic acid, alginic acid, benzoic acid, caproic acid, caprylic acid, capric acid, lauric acid, stearic acid, isostearic acid, behenic acid, malic acid, succinic acid, tartaric acid, citric acid, ethylenediaminetetraacetic acid, palmitic acid, stearic acid, and mixtures thereof. Among these, ethylenediaminetetraacetic acid is preferred. Preferred acids are saturated species. Unsaturated acids may result in generation of odorants in the compositions.

Also, salts of these organic acids may be employed. Sodium and potassium salts are preferred.

In any case, the components present in the oxygen scavenging composition should be such that if dissolved in water, a highly alkaline aqueous solution is not formed. By highly alkaline aqueous solution is meant one having a pH above 9. Preferably the pH of an aqueous solution of a component or components of the compositions of the invention will be 8 or lower, more preferably 7 or lower for aqueous solutions of the components. High concentrations of hydroxide ion that might be present in any water layer associated with the oxidizable metal component would compete and interfere with the complexing or chelating ability of electrolyte ions. It is believed that, when iron is used as the oxidizable metal, the ability to facilitate formation of ferrous ion complexes or chelates promotes the electrochemical oxidation reaction. Certain electrolyte combinations are especially effective in this regard and include sodium chloride plus ferric ammonium citrate, and also include ethylenediaminetetraacetic acid plus ferric ammonium citrate.

Electrolytes that attract water are preferred for use in the oxygen scavenging compositions. Components that provide moisture enhance the electrochemical reaction. Ability to attract moisture is quantified by measuring the equilibrium moisture content of a material, which is the relative humidity at equilibrium between a saturated solution of the compound and the air space above it. The equilibrium moisture constant for lithium bromide, which is a deliquescent compound, is 7% relative humidity. Thus, water will form on its surface at 7% relative humidity. Some preferred electrolytes include sodium chloride, potassium acetate, zinc ammonium chloride, sodium bromide, ammonium sulfate and citric acid.

The amount of polymeric component that is present in the oxygen scavenging compositions of the invention may be a relatively small proportion of the composition, e.g. less than 1 wt. %. Many useful compositions, however, will incorporate much higher concentrations of polymer, especially those compositions designed for forming into lids, caps and containers. In such cases the amount of polymer will generally range from 20 to 99 wt. % based on the total weight of the oxygen scavenging composition. Preferably, the amount of polymer will be 30 to 70 wt. %, based on the total weight of the composition.

The oxygen scavenging compositions may be in the form of concentrates. Concentrates are useful in melt processes, such as processes involving extrusion of thermoplastic resins which are commonly used for fabrication packaging materials such as film and containers. A concentrate preferably contains at least 80 parts by weight of the combination of oxidizable metal and iron salt per 100 parts by weight of polymer. Generally, the concentrate will contain at least 50 parts by weight of the combination of oxidizable metal and iron salt per 100 parts by weight polymer.

The oxygen scavenging compositions of the invention may be used with or without addition of further components such as additional polymers to produce fabricated articles, such as laminate layers for use in multi-layer sheets, films or other structures, lids, caps, labels, pads, containers and other packaging materials. Thermoset polymers that incorporate the oxygen scavenging compositions can be used in general rubber applications, such as tubing, or as coatings on other substrates.

When rapid removal of oxygen from a package is desired, polymers having high oxygen permeability are preferred. In certain applications, for example when a composition comprising a polymer and oxygen scavenging composition is used as a cap liner in a packaging article, it is desirable that oxygen moves rapidly from the inside of the container, e.g. a bottle, to contact the oxygen scavenging composition. Oxygen may be present in the package as a result of the manufacturing process or in some cases it may diffuse into the package during storage. Oxygen permeability is expressed as OPV (Oxygen Permeability Value). Low density polyethylene, which is a relatively permeable polymer, has an OPV value at ambient temperatures and 50% relative humidity of about 450 cc oxygen mil/100 in² day atm. Ethylene vinyl acetate resins, for example Elvax® EVA resins available from E. I. du Pont de Nemours and Company, have OPV values ranging up to 1000 cc oxygen mil/100 in² day atm for those grades having the highest vinyl acetate levels. Elvax® EVA carrier resins thus have superior value over polyethylene for oxygen scavenging. Resins having OPV at ambient temperatures and 50% relative humidity of 450 cc oxygen mil/100 in² day atm will be particularly useful in certain container applications. For those compositions having low equilibrium moisture content or not having a source of water within the scavenging composition itself, the water permeability of the resin is important for promotion of rapid oxygen uptake. Water permeation is measured and reported as Water Vapor Transmission rate (WVTR). The WVTR for low density polyethylene is approximately 1.5 g water/100 in day, which is considered to be only slightly permeable to water vapor. Certain grades of Elvax® resins have WVTR values of 4 g water/100 in² day and therefore exhibit faster water permeation rates than low density polyethylene. The Elvax® resin, and others having WVTR values of 4 g water/100 in² day or more would therefore be preferred carrier resins for oxygen scavenging compositions of the invention that have low equilibrium moisture content.

In other applications the polymer present in the oxygen scavenging compositions will act as a barrier to permeation of oxygen from outside the packaging material to inside the packaging material. In such applications it is desirable to utilize a polymer having low oxygen permeability but high water permeability. An example of such a polymer is a copolymer of ethylene and vinyl alcohol, available from Kuraray Company Ltd. Ethylene vinyl alcohol copolymer having 32 wt. % ethylene copolymerized comonomer units has a low OPV value at 90% relative humidity of about 0.3 cc oxygen mil/100 in² day atm and a WVTR of about 3.8 g water mil/100 in 2 day.

When the oxygen scavenging compositions of the invention are fabricated into polymer films, whether mono or multilayered, the oxygen scavenging property may be enhanced by orienting or stretching the polymer film to generate porous structures.

It is believed that the chemistry that forms the basis of the activity of the oxygen scavenging compositions of the invention involves consumption of the ingredients. For example, using iron metal as an example, the iron will be consumed in the oxidation reaction. Depending on the environment of the iron, its capacity for consuming oxygen is between 100 cc of oxygen to 300 cc of oxygen per gram of iron metal. Design of polymeric articles that contain the oxygen scavenging composition and selection of the level of iron in the polymer depends on the design requirements for the packaged material that is being protected from oxygen. For example, higher percentages of oxidizable metal in the polymer are useful for faster reduction rates of oxygen and/or for reducing the oxygen levels in the package to very low levels. A combined level of oxidizable metal and iron salt in the compositions of 1% by weight per 100 parts by weight of the polymer component can be sufficient to produce an oxygen scavenging effect. Preferably, however, at least 10% by weight per 100 parts by weight polymer will be used. Specific levels will depend on the particular end use and polymer into which the oxygen scavenging composition is to be incorporated. The use of higher levels can result in effects such as undesirably high melt viscosity, high density, and increased embrittlement. However, in some instances, levels of the combined oxidizable metal component and iron salt may be as high as 90% by weight.

The compositions of the invention may be easily prepared by common mixing techniques. For example, the components may be mixed together in an extruder. For continuous production of polymer containing a well-dispersed mixture of oxidizable metal and ferric ammonium salt, a twin-screw extruder, such as a Werner & Pfleiderer twin-screw extruder, may be used. The components can be fed from separate ports or from one feed port as a dry blend. Nitrogen purging of the feed port will minimize slight pre-reactions between iron and oxygen. The components may be heated in the extruder to a temperature above the melting temperature of the polymer and extruded as a strand onto a dry, moving belt for cooling and subsequent pelletization. The pellets may then be bagged, preferably in foil lined bags to minimize exposure to oxygen and water, or in high density polyethylene bags for protection from water.

Other embodiments of the invention are laminates, by which is meant multi-layered structures, and may also include monolayer films. Laminates of the invention may comprise two or more layers. The oxygen scavenging composition of the invention will comprise a first layer. Such compositions may include an additional polymer or polymers to form the material that comprises this first layer. As described above, the oxygen scavenging compositions may further include additional components that do not substantially interfere with the oxygen scavenging reaction. The additional layer may be formed of any material, including the same composition as the first layer. The second layer may also comprise another polymeric layer, a metal layer or metal foil layer, a ceramic or glass layer, a coextrudable adhesive layer, a hot melt adhesive layer, a solvent based adhesive layer, a fabric or other porous layer, for example Tyvek® industrial packaging. Examples of useful laminates of these types include flexible film layers of the following constructions: polypropylene/adhesive tie layer/oxygen scavenging composition of the invention/adhesive tie layer/ionomeric polymer; polyethylene/adhesive tie layer/ethylene vinyl alcohol/adhesive tie layer/oxygen scavenging composition of the invention/adhesive tie layer/polypropylene; metallized Mylar® polyester film/adhesive tie layer/oxygen scavenging composition of the invention/adhesive tie layer/sealant layer. The first of these constructions might be useful as a lid material with the polypropylene as the outside layer. The second would be suitable for film wrap. The third would be suitable as a lid material, with the metallized Mylar® polyester film as the outside layer. A laminate structure that would be useful for bottle caps is one having an outside layer of polypropylene and a second layer of an oxygen scavenging composition of the invention wherein the polymer is ethylene vinyl acetate. Another laminate structure useful for bottle caps is one having aluminum as an outside layer, an oxygen scavenging composition of the invention wherein the polymer is ethylene vinyl acetate as a second layer, and ethylene vinyl acetate as the inside layer. A laminate useful as a cup or tray material is one formed of an outside layer of polypropylene, a second layer that is an adhesive tie layer, a third layer that is ethylene vinyl alcohol copolymer, a fourth that is an adhesive layer, a fifth that is an oxygen scavenging composition of the invention wherein the polymer is polyethylene, and an inside layer that is polyethylene. Another laminate useful as a tray material is one formed of an outside layer of high density polyethylene, a second layer that is a co-extrudable adhesive, a third layer that is an oxygen scavenging composition of the invention wherein the polymer is polyethylene, and an inside layer that is polyethylene.

Typical polymers used in film layers for packaging include polypropylene, low density polyethylene, polylactic acid, polyethylene terephthalate and high density polyethylene. Tie layers formed of coextrudable adhesives are commonly used in such constructions.

The oxygen scavenging compositions of the invention and laminates of the invention can be fabricated, for example by melt processing, into shaped articles or films used in packaging applications.

In certain embodiments the compositions will scavenge oxygen in a way that removes oxygen from packaged material. In order to provide a lengthy period of oxygen scavenging activity, the scavenging composition should be separated from air outside the package by a barrier that resists permeation of oxygen. One method is to provide a thick container wall layer, for example a 10 mil thick polypropylene layer. Alternatively, a thin layer of a polymer that has low permeability to oxygen can provide longer life for the scavenging composition. For example, ethylene vinyl alcohol copolymers (EVOH) of 0.2 mil thickness would provide the same protection as a 20 mil layer of the more permeable polypropylene. Once protected from external oxygen, the location of the oxygen scavenging layer can be varied within the package. For example, a laminate layer comprising the oxygen scavenging composition may be a separate label affixed to the inner wall of the package, a layer in the lid of a cup or tray, a bottle cap liner, or a layer of a laminated container wall. An example of the latter would be a laminate of polypropylene, Bynel® co-extrudable adhesive resin, EVOH, a layer comprising the oxygen scavenging composition, Bynel® adhesive resin, polypropylene, with the first listed polypropylene layer as the outside layer.

The oxygen scavenging compositions of the invention may also be used in sachets or packets, as a separate inclusion within a packaging article to absorb headspace oxygen. The compositions, when utilized for this purpose, may be a part of the packet material, such as a layer or they may be in the form of a powder within the packet. The compositions may additionally comprise additional ingredients, such as polymeric resins, and be formed into pellets that are contained within a packet.

Packaged oxygen sensitive materials that may be protected using the compositions of the invention include, but are not limited to milk, yogurt, cheeses, soups, beverages such as wine, beer and fruit juices, pre-cooked meals, pharmaceuticals, and powders or materials that are difficult to treat by nitrogen purging, such as flour or noodles. In addition, the oxygen scavenging compositions of the invention and laminates of the invention protect packaged articles from the secondary effects of oxygen, such as insect damage, fungal growth, mildew and bacterial growth.

The invention is illustrated by the following examples of certain embodiments.

### EXAMPLES

### Example 1

A 94 g sample of a blend containing 50 wt. % ethylene vinyl acetate resin having a vinyl acetate content of 18 wt. % and a melting temperature of 90° C., 44 wt. % metallic iron (H200 iron available from ARS Technologies Inc.), 4 wt. % ferric ammonium citrate (16.5-18.5 wt. % iron, Aldrich Chemical Co.) and 2 wt. % sodium chloride (200 mesh, Morton Salt Co.) was introduced to a Haake Rheocord 9000 plastograph mixer. The iron, sodium chloride and ferric ammonium citrate were premixed in a Waring commercial high-speed blender under nitrogen for 30 seconds before being combined with the ethylene vinyl acetate resin. The material was melt-mixed at 160° C., 100 rpm, for 7 minutes in the Haake mixer, then emptied into a stainless steel tray under nitrogen and allowed to cool for 15 minutes under nitrogen. The cooled sample was stored under nitrogen. A portion of the sample was compression molded at 140° C. and rapidly cooled under pressure to ambient temperature. The resultant 15-20 mil thick, 5-inch diameter disk was stored under nitrogen. A sample of the disk weighing approximately 1 g was tested to determine its oxygen scavenging characteristics. Ten layers of 1-inch square dampened paper toweling were placed in the bottom of a 50 ml Kjeldahl reaction flask to create a 100% relative humidity atmosphere. The test sample was placed onto the damp towels. With the flask open to the atmosphere a 50 ml graduated tube of the Kjeldahl flask was lowered into a flask of water and the Kjeldahl flask was then stoppered with a glass stopper. As oxygen was consumed the water rose in the graduated tube. Corrections for barometric pressure and temperature were made by comparing the change in water level with that of a Kjeldahl flask that contained damp paper toweling and an approximately 1 g sample of the ethylene vinyl acetate resin that contained no other ingredients. After 24 hours the water level in the graduated tube rose to a level that indicated 4 cc oxygen had been removed from the approximately 125 ml. of air in the flask-graduated tube apparatus.

### Example 2

The same equipment, materials and procedure described in Example 1 were used to prepare a blend composed of 50 wt. % of the ethylene vinyl acetate resin, 45 wt. % of the metallic iron and 5 wt. % ferric ammonium citrate. The metallic iron and ferric ammonium citrate were premixed under nitrogen for 30 seconds. The polymer and pre-mixed material were melt mixed, isolated, stored and introduced to the same Kjeldahl flask containing substantially the same quantity of dampened paper toweling as in Example 1. After 24 hours, oxygen uptake was 0.3 cc.

### Example 3

The same equipment, materials and procedure described in Example 1 were used to prepare an 88 g blend composed of 50 wt. % of the ethylene vinyl acetate resin, 31 wt. % of the metallic iron, 16 wt. % sodium chloride and 3 wt. % ferric ammonium citrate. The polymer and pre-mixed material were melt mixed, isolated, stored and introduced to the same Kjeldahl flask as described in Example 1 containing substantially the same quantity of dampened paper toweling. After 24 hours, oxygen uptake was 5 cc.

### Example 4

The same equipment, materials and procedure described in Example 1 were used to prepare a 75 g polymer blend of the invention, except the Waring blending step was eliminated. In addition to the materials used in Example 1, the blend additionally contained tribasic sodium citrate. The blend was composed of 65 wt. % of the ethylene vinyl acetate resin, 25 wt. % of the metallic iron, 5 wt. % ferric ammonium citrate and 5 wt. % tribasic sodium citrate (Aldrich Chemical Co.). The polymer and other materials were melt mixed, isolated, stored and introduced to the same Kjeldahl flask as described in Example 1 containing substantially the same quantity of dampened paper toweling. After 24 hours, oxygen uptake was 2 cc.

### Example 5

The same equipment, materials and procedure described in Example 1 were used to prepare a 75 g polymer blend of the invention, except the Waring blending step was eliminated. In addition to the materials used in Example 1, the blend additionally contained ethylenediaminetetraacetic acid (“EDTA”). The blend was composed of 50 wt. % of the ethylene vinyl acetate resin, 24 wt. % of the metallic iron, 5 wt. % ferric ammonium citrate and 21 wt. % EDTA (Aldrich Chemical Co.). The polymer and pre-mixed material were melt mixed, isolated, stored and introduced to the same Kjeldahl flask as described in Example 1 containing substantially the same quantity of dampened paper toweling. After 24 hours, oxygen uptake was 4 cc.

### Example 6

The same equipment, materials and procedure described in Example 1 were used to prepare a 75 g polymer blend of the invention, except the Waring blending step was eliminated. The blend was composed of 67.5 wt. % of the ethylene vinyl acetate resin, 27 wt. % of the metallic iron, and 5.5 wt. sodium chloride. The polymer and other materials were melt mixed, isolated, stored and introduced to the same Kjeldahl flask as described in Example 1 containing substantially the same quantity of dampened paper toweling. After 24 hours, oxygen uptake was 0.2 cc.

### Example 7

A blend containing 67.5 wt. % ethylene vinyl acetate resin having a vinyl acetate content of 18 wt. % and a melting temperature of 90° C., 27 wt. % metallic iron (H200 iron available from ARS Technologies Inc.), and 5.5 wt. % of ferric ammonium citrate (16.5-18.5 wt. % iron, Aldrich Chemical Co.) was introduced to a Haake Model 9000 plastograph mixer. The material was melt-mixed at 160° C., 100 rpm, for 7 minutes in the Haake mixer, then emptied into a stainless steel tray under nitrogen and allowed to cool for 15 minutes under nitrogen. The cooled sample was stored under nitrogen. A portion of the sample was compression molded at 140° C. and rapidly cooled under pressure to ambient temperature. The resultant 15-20 mil thick, 5-inch diameter disk was stored under nitrogen. A sample of the disk weighing approximately 1 g was tested to determine its oxygen scavenging characteristics. Ten layers of 1-inch square dampened paper toweling were placed in the bottom of a 50 ml Kjeldahl reaction flask to create a 100% relative humidity atmosphere. The test sample was placed onto the damp towels. With the flask open to the atmosphere a 50 ml graduated tube of the Kjeldahl flask was lowered into a flask of water and the Kjeldahl flask was then stoppered with a glass stopper. As oxygen was consumed the water rose in the graduated tube. Corrections for barometric pressure and temperature were made by comparing the change in water level with that of a Kjeldahl flask that contained damp paper toweling and an approximately 1 g sample of the ethylene vinyl acetate resin that contained no other ingredients. After 1, 3, 21, 93 and 168 hours the water level in the graduated tube rose to a level that indicated respectively 0.0, 0.0, 0.0, and 0.8 cc oxygen had been removed from the approximately 125 ml. of air in the flask-graduated tube apparatus.

What is claimed is:

1. An oxygen scavenging composition comprising
A. a polymer having less than 5 aliphatic carbon-carbon double bonds per 100 copolymerized monomer units;
B. an oxidizable metal; and
C. a compound selected from the group consisting of iron salts having ferric ammonium cations and mixtures thereof, wherein said iron salts have solubilities in water at 25° C. of at least 1 g/100 g water.

2. An oxygen scavenging composition of claim 1 wherein the oxidizable metal is selected from the group consisting of iron, copper, manganese and cobalt.

3. An oxygen scavenging composition of claim 2 wherein the oxidizable metal is iron.

4. An oxygen scavenging composition of claim 1 wherein the polymer is selected from the group consisting of polyamides, polyesters, polystyrenes, polycarbonates, polyvinyl acetate, polyvinyl chloride, polyolefin homopolymers and copolymers, copolymers of ethylene and a polar comonomer, ionomers of ethylene acrylic acid copolymers, ionomers of ethylene methacrylic acid copolymers and ionomers of ethylene maleic acid copolymers.

5. An oxygen scavenging composition of claim 1 wherein the polymer is a thermoplastic resin.

6. An oxygen scavenging composition of claim 1 additionally comprising an electrolyte that is not a ferric ammonium salt selected from the group consisting of salts of organic acids and salts of inorganic acids wherein the cations of said salts are selected from the group consisting of alkali metal cations, alkaline earth metal cations, transition metal cations, quaternary ammonium cations, and quaternary phosphonium cations and mixtures thereof and wherein said electrolyte has a solubility in water at 25° C. of at least 1 g/100 g water.

7. An oxygen scavenging composition of claim 1 additionally comprising an additional polymer, different from the polymer of component A, said additional polymer being selected from the group consisting of polymers having less than 5 aliphatic carbon-carbon double bonds per 100 copolymerized monomer units.

8. An oxygen scavenging composition of claim 1 additionally comprising a metal oxide.

9. A laminate comprising
A. a first layer comprising
1. a polymer having less than 5 aliphatic carbon-carbon double bonds per 100 copolymerized monomer units;
2. an oxidizable metal; and
3. a compound selected from the group consisting of iron salts having ferric ammonium cations and mixtures thereof, wherein said iron salts have solubilities in water at 25° C. of at least 1 g/100 g water; and
B. at least one additional layer.

10. A laminate of claim 9 wherein at least one additional layer comprises a thermoplastic polymer.

11. A laminate of claim 10 wherein the thermoplastic polymer is selected from the group consisting of polypropylene, polyethylene and ethylene vinyl alcohol.

12. A monolayer film comprising at least one polymer having less than 5 aliphatic carbon-carbon double bonds per 100 copolymerized monomer units, an oxidizable metal and a compound selected from the group consisting of iron salts having ferric ammonium cations and mixtures thereof, wherein said iron salts have solubilities in water at 25° C. of at least 1 g/100 g water.

13. An article comprising at least one polymer having less than 5 aliphatic carbon-carbon double bonds per 100 copolymerized monomer units, an oxidizable metal and a compound selected from the group consisting of iron salts having ferric ammonium cations and mixtures thereof, wherein said iron salts have solubilities in water at 25° C. of at least 1 g/100 g water.

14. A packet formed of an oxygen-permeable substance, wherein an oxygen scavenging composition is present within said packet, said composition comprising
A. a polymer having less than 5 aliphatic carbon-carbon double bonds per 100 copolymerized monomer units;
B. an oxidizable metal; and
C. a compound selected from the group consisting of iron salts having ferric ammonium cations and mixtures thereof, wherein said iron salts have solubilities in water at 25° C. of at least 1 g/100 g water.

15. A composition of claim 1 wherein the iron salt is ferric ammonium citrate.
